(19) United States
(12) Patent Application Publication
(10) Pub. No.: US 2026/0172439 A1
(43) Pub. Date: Jun. 18, 2026

(54) DETERMINING SECURITY RISK RATING

(71) Applicant: NVIDIA Corporation, Santa Clara, CA (US)

(72) Inventor: Phani Bhushan Avadhanam, San Diego, CA (US)

(21) Appl. No.: 18/986,351

(22) Filed: Dec. 18, 2024

(51) Int. Cl. H04L 9/40; H04L 41/16

(52) U.S. Cl. CPC H04L 63/1433; H04L 41/16

(57) ABSTRACT

Devices, systems, and techniques for assessing and managing network security risks associated with an artificial intelligence (AI) model executed by a primary computing system. The techniques include receiving one or more executable files implementing the AI model. The techniques include determining, based at least in part on the one or more attributes, a risk rating associated with the AI model. The techniques include causing execution of an action with respect to the AI model based at least in part on the risk rating.

### TECHNICAL FIELD

At least one embodiment pertains to assessing and managing network security risks associated with artificial intelligence models executed by a primary computing system. For example, at least one embodiment pertains to a primary computing system employing a risk assessment system to assess and define a level of risk associated with an ingested artificial intelligence model.

### BACKGROUND

Computing systems frequently ingest data from various sources that is stored and shared with downstream users. Data that is received from a third-party source may expose the recipient computer system (and infrastructure including sensitive internal networks) to potentially malicious files, such as objects that may be infected with malware, viruses, ransomware, trojan horses, and the like.

In particular, artificial intelligence (AI) models (e.g., large language models (LLMs)) may be received and ingested by an application of a computing system associated with an organization (e.g., a recipient application). Disadvantageously, many AI/LLM models can be manipulated and abused by modifying one or more model attributes (e.g., model shapes, model operators, model inferences). Specifically, the model attributes can be susceptible to one or more abuse scenarios such as unauthorized model dumping, intellectual property theft or leakage, hyperparameter leakage, etc. In such cases, a nefarious actor can craft AI/LLM models (e.g., such as models in the ONNX format) to induce a security attack against the recipient computing system and related application(s). Furthermore, such attacks perpetrated by a malicious AI/LLM model exposes not only the recipient application to risks, but also exposes one or more downstream users of the application to potential malware infection on local user devices.

### BRIEF DESCRIPTION OF DRAWINGS

FIG. 1 is a block diagram of an example risk assessment system communicatively coupled to one or more computing systems associated with one or more AI models to be consumed by one or more applications executed by one or more primary computing systems, in accordance with at least one embodiment;

FIG. 2 illustrates an example attribute risk assessment engine of a risk assessment system configured to perform operations to generate an attribute risk rating for an example attribute associated with an ingested AI model.

FIG. 3 illustrates an example data structure including a set of conditions or rules that can be employed by the attribute risk assessment engine to determine the attribute risk rating for an example AI model attribute, according to at least one embodiment;

FIG. 4 depicts an example data structure representing attribute risk rating information generated by processing logic of a risk assessment system, according to at least one embodiment;

FIG. 5 illustrates an example data structure including a set of conditions or rules that can employed by the AI model risk assessment engine of a risk assessment system to determine an overall AI model risk rating, according to at least one embodiment;

FIG. 6 illustrates an example data structure including a mapping between an overall AI model risk rating and a corresponding network isolation workflow that may be used by the workflow manager of a risk assessment system, according to at least one embodiment;

FIG. 7 is a flow diagram of an example method related to assessing and managing a security risk level associated with an AI model ingested for use by one or more applications executed by a primary computing system, in accordance with at least one embodiment;

FIG. 8A is a block diagram of an example generative language model system suitable for use in implementing some embodiments of the present disclosure;

FIG. 8B is a block diagram of an example generative language model that includes a transformer encoder-decoder suitable for use in implementing some embodiments of the present disclosure;

FIG. 8C is a block diagram of an example generative language model that includes a decoder-only transformer architecture suitable for use in implementing some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

A wide range of applications ingest and store data associated with an AI model. The applications further share that data with one or more downstream users. Frequently, the ingested data is received from one or more third-party sources, which exposes those applications and downstream users to potentially malicious files (e.g., objects that may be infected with malware, viruses, ransomware, trojan horses, and more). In particular, ingested AI models received from an untrusted third party source may include underlying AI model attributes that present abuse risks and can be used to induce a security attack.

The present invention addresses the aforementioned problems and other technological challenges related to protecting a primary computing system (e.g., applications, services, underlying infrastructure, etc.) from security risks associated with ingesting files of an AI model. In some embodiments, the primary computing system employs a risk assessment system which receives and ingests files of an AI model (including one or more executable files implementing the AI model ) received from an untrusted source (e.g., a third-party source). According to embodiments, the risk assessment system scans the one or more executable files implementing the AI model to identify one or more attributes (herein referred to as an “AI model attribute” or collectively as “AI model attributes”) of the AI model. In an embodiment, the risk assessment system identifies a risk rating associated with each of the AI model attributes of set of identified AI model attributes associated with the AI model. According to embodiments, each identified AI model attribute is associated with a determined attribute risk rating (e.g., a low risk rating, a medium risk rating, and a high risk rating). The determined attribute risk rating represents a level of potential threat or vulnerability to a system or data that is associated with a particular AI model attribute.

In an embodiment, the risk assessment system maintains a data structure including a set of AI model attributes (e.g., a collection of operators and attributes), where each AI model attribute in the data structure is associated with the determined attribute risk rating. In an embodiment, for each identified AI model attribute, an attribute risk rating is determined using a projected impact on the primary computing system for each abuse scenario to which a particular AI model attribute is vulnerable, and a likelihood of a particular AI model attribute causing damage to the primary computing system. Specifically, in an embodiment, the risk assessment system identifies one or more possible abuse scenarios (e.g., the one or more potential abuse scenarios to which a particular AI model attribute is vulnerable). Example abuse scenarios include, but are not limited to, an unauthorized model dumping scenario, an intellectual attribute theft or leakage scenario, a hyperparameter leakage scenario, a model retraining attack scenario, a model refitting with unauthorized data scenario, a malicious model alteration scenario, etc. In an embodiment, for each identified possible abuse scenario, the risk assessment system calculates a projected impact to the primary computing system (e.g., an impact to the data and applications of the primary computing system) if the abuse scenario occurs (herein the “abuse scenario impact”). In an embodiment, the abuse scenario impact may be categorized as one of high impact, medium impact, or low impact for each abuse scenario associated with an identified AI model attribute of the ingested AI model. According to embodiments, the risk assessment system identifies a maximum threat level associated with the one or more identified abuse scenarios. In an embodiment, an abuse scenario identified as having the maximum threat level (herein the “maximum threat abuse scenario”) is identified by evaluating the determined abuse scenario impact corresponding to each of the identified abuse scenarios. Accordingly, the risk assessment system identifies an impact associated with the maximum threat abuse scenario (herein the “maximum abuse scenario impact”. For example, an AI model attribute may be associated with a set of related abuse scenarios including at least one abuse scenario having a high impact. In this example, the risk assessment system determines that the maximum abuse scenario impact is high. The risk assessment system then determines that the AI model attribute is associated with a high maximum abuse scenario impact (e.g., since there is at least one abuse scenario corresponding to the AI model attribute that is determined to have a high impact).

According to embodiments, the risk assessment system determines a likelihood of a particular AI model attribute causing damage to the primary computing system (herein the “damage likelihood”). For example, for each AI model attribute, the risk assessment system may assign a damage likelihood grade (herein the “damage likelihood grade”), such as “High/Yes” grade or “Low/No” grade, to the particular AI model attribute.

According to embodiments, the risk assessment system determines the attribute risk rating for a particular AI model attribute based on the identified impact associated with the maximum threat abuse scenario (i.e., the maximum abuse scenario impact) and the damage likelihood grade associated with the particular AI model attribute. For example, each AI model attribute of the AI model may be assigned a high attribute risk rating if the damage likelihood grade is “High/Yes” and the maximum abuse scenario impact corresponding to the set of potential abuse scenarios is “High Impact”.

In an embodiment, the risk assessment system determines an overall risk rating of the AI model (herein the “AI model risk rating”) based at least in part on the attribute risk ratings associated with the identified AI model attributes of the AI model that are stored in the above-mentioned data structure (e.g., the AI model may be determined to represent a low AI model risk rating, a medium AI model risk rating, a high AI model risk rating, or a critical AI model risk rating). In an embodiment, the AI model risk rating may be determined by comparing a number of identified AI model attributes having a high attribute risk rating (herein “Number_{HighAttributeRiskRating(HARR)}”) to one or more thresholds. For example, the AI model risk rating for the AI model may be identified as “low” if the Number_{HARR} associated with the AI model is less than a first threshold level of high risk AI model attributes. In another example, the AI model risk rating for the AI model may be identified as “medium” if the Number_{HARR} associated with the AI model is greater than the first threshold level and greater than a second threshold level of high risk AI model attributes. In another example, the AI model risk rating may be identified as “high” if the Number_{HARR} associated with the AI model is greater than the second threshold level and less than a third threshold level of high risk AI model attributes. In another example, the AI model risk rating may be identified as “critical” if the Number_{HARR} associated with the AI model is greater than the third threshold level.

According to embodiments, the risk assessment system may execute an action based on the AI model risk rating. In an embodiment, the action may include the execution of a selected network isolation workflow from a set of network isolation workflows.

In an embodiment, the risk assessment system selects a network isolation workflow to be executed based on the identified AI model risk rating. According to embodiments, a network isolation workflow may include one or more steps, operations, processes configured to divide or partition a network associated with the primary computing system into separate segments or subsets, each acting as its own small network. According to embodiments, the risk assessment system is configured to execute a variety of different network isolation workflows having different degrees of security or isolation levels. In an embodiment, the configuration of a network isolation workflow may include the execution of one or more steps or operations (e.g., network isolation operations) in accordance with a suitable network management architecture (e.g., OpenShift Software-Defined Networking (SDN) including, for example, executing operations relating to configuring a network cluster to enable communications between respective pods (e.g., groups of containers that share resources such as storage and network resources), executing operations relating to joining two or more projects to allow network traffic between pods and services in different projects, executing operations relating to isolating a project so that pods and services in other projects cannot access pods and services of the isolated project, executing operations relating to disabling network isolation for a project, etc.

For example, if the AI model risk rating is “critical”, the risk assessment system may cause execution of a first network isolation workflow having a highest isolation level. In another example, if the AI model risk rating is “high”, the risk assessment system may cause execution of a second network isolation workflow having a second highest isolation level. In another example, if the AI model risk rating is “medium”, the risk assessment system may cause execution of a third network isolation workflow having a third highest isolation level. In another example, if the AI model risk rating is “low”, the risk assessment system may cause execution of a fourth network isolation workflow having a lowest isolation level.

In an embodiment, the network isolation workflow associated with high risk AI models may be implemented using one or more network solutions, such as, for example, Software Defined Network (SDN) solutions, OpenStack Virtual Network (OVN-Kubernetes) solutions, Open Stack Virtual Switch (OVS) solutions, etc.

In an embodiment, the risk assessment system may store a hash value corresponding to the AI model risk rating assigned to the AI model. The stored hash value may be used by the risk assessment system in response to receipt of the AI model at a subsequent time.

Accordingly, aspects of the present disclosure provide a risk assessment system that can assess and define a level of risk associated with an ingested AI model, thereby protecting a primary computing system from security risks associated with ingesting files of the AI model.

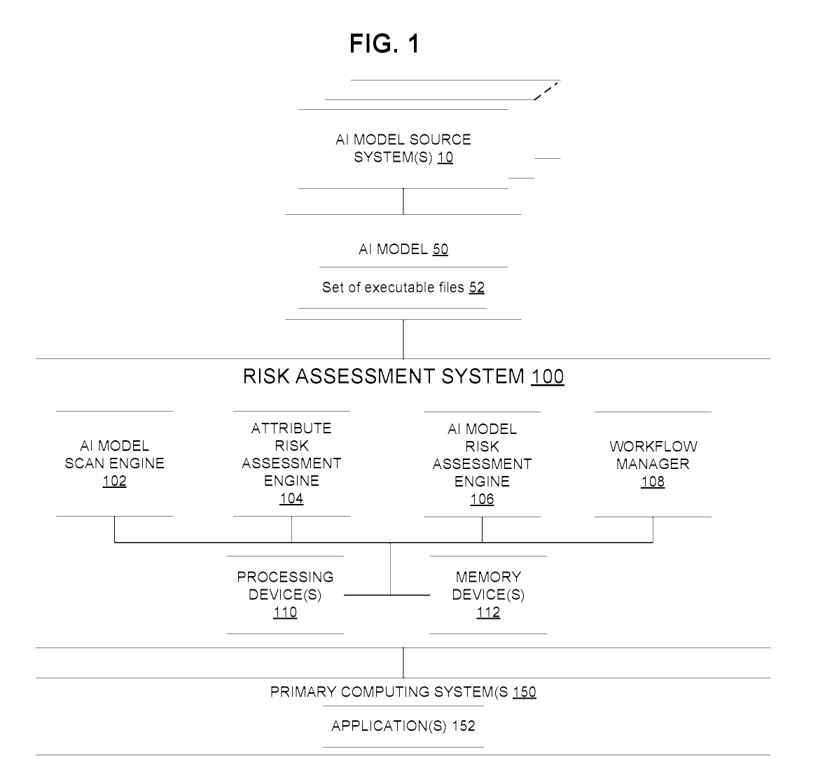

FIG. 1 is a block diagram of an example risk assessment system 100 communicatively coupled to one or more computing systems 10 associated with one or more AI models to be consumed by one or more applications 152 executed by one or more primary computing systems 150, according to one or more embodiments. According to an embodiment, the risk assessment system 100 ingests an AI model 50 including a set of executable files 52 from one or more of the source systems (herein “AI model source systems”) 10. In an embodiment, the AI model 50 may be uploaded for use by one or more applications 152 associated with one or more primary computing systems 150. According to embodiments, prior to use by the one or more applications 152, the system 100 ingests the AI model 50 and performs risk assessment management, as described in detail.

According to embodiments, the system 100 includes control logic (e.g., an AI model scan engine 102, an attribute risk assessment engine 104, an AI model risk assessment engine 106, a workflow manager 108) configured to manage the risks associated with the ingested AI model 50. According to embodiments, the system 100 includes one or more processing devices 110 configured to execute instructions stored in one or more memory devices 112, the instructions for performing the operations and steps associated with the control logic of the system 100, described in detail herein.

According to embodiments, the one or more processing device 110 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. According to embodiments, the one or more processing devices 110 can also be one or more special-purpose processing devices such as an application specific integrated circuit (ASIC), a field programmable gate array (FPGA), a digital signal processor (DSP), network processor, or the like.

According to embodiments, the one or more memory devices 112 includes an embedded memory configured to store instructions for performing various processes, operations, logic flows, and routines that control operation of the risk assessment system 100. According to embodiments, the one or more memory devices can include a main memory (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), and a data storage system, which communicate with each other via a bus.

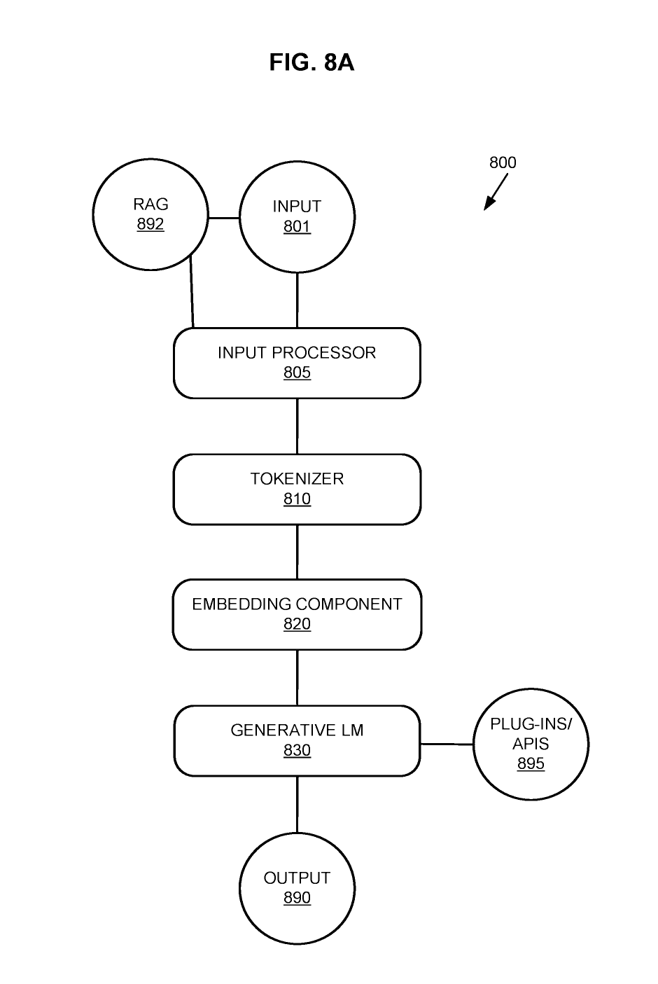

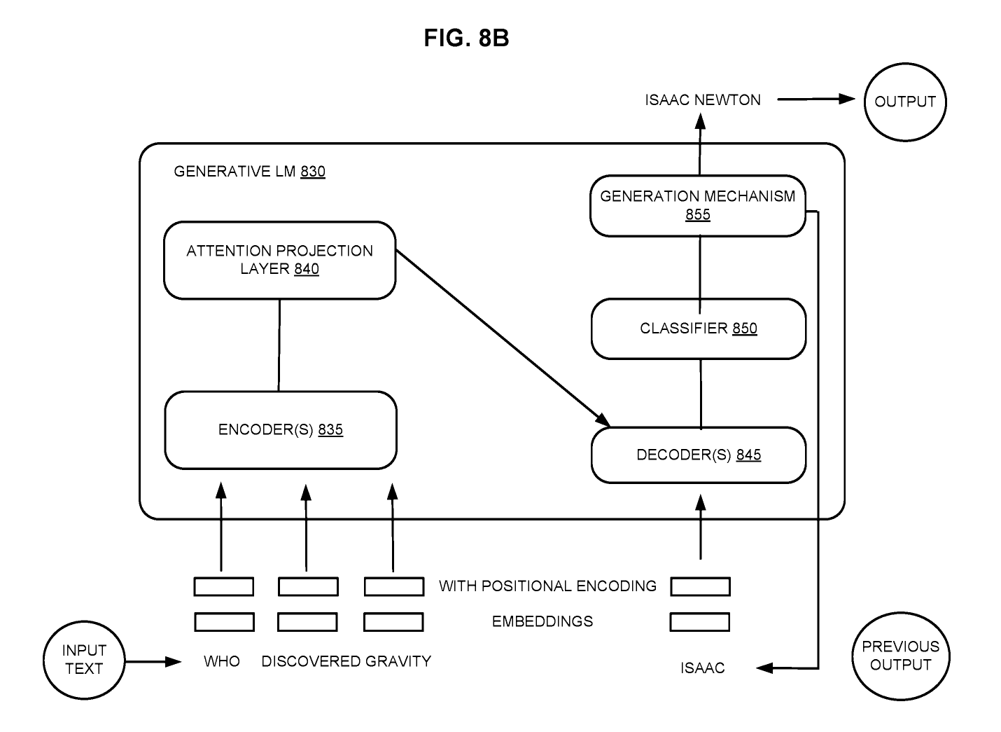

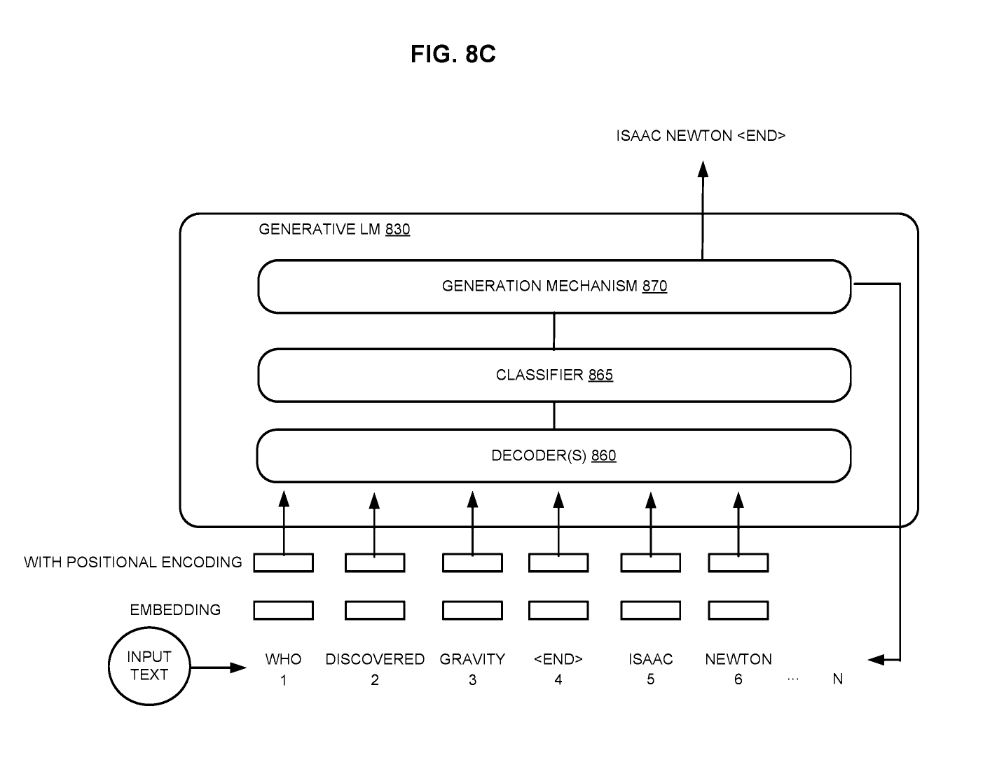

According to embodiments, the AI model 50 may automate tasks traditionally performed by humans including creating representation of artificial characters, e.g., digital avatars, game characters, chatbots, and/or the like. Example AI models include discriminative models and generative models. Discriminative AI models are trained to classify inputs by identifying patterns in training data (e.g., sounds, images, actions, face expressions, texts, and/or other data), such as presence of a particular type of an object within a training image or a particular word within a training speech or text or data. Generative AI models are trained to generate new data that is similar to human-created (e.g., texts) or naturally occurring (e.g., images) training data. Training can be supervised, self-supervised, unsupervised, reinforced, instructional fine-tuning, and/or the like. After successful training, deployed AI models are used to classify and/or generate new data. For example, generative language models – such as large language models (LLMs) – are capable of supporting conversations in a natural language, understanding speaker’s intent and emotions, explaining complex topics, creating new texts upon receiving suitable prompts, providing advice regarding topics of interest to a user, processing image, audio, and/or other data types, and/or performing other functions. Further details relating to LLMs are described below with reference to FIGS. 8A-8C.

According to embodiments, the AI model 50 (e.g., a deep learning model, an LLM, etc.) can include hundreds of millions or billions of learnable parameters (e.g., weights and biases of artificial neurons) and are trained using massive amounts of training data. Training of such complex models can be performed using distributed computing where multiple (e.g., tens or even hundreds of) computing nodes learn from different sets of training data in parallel. Individual computing nodes deployed in distributed training can include various processing units, such as central processing units (CPUs) and graphics processing units (GPUs). According to embodiments, the computing nodes may include some or all of one or more GPUs, CPUs, parallel processing units (PPUs), data processing units (DPUs), or accelerators, and/or other suitable processing devices capable of performing computing associated with the AI model 50.

According to embodiments, the AI model scan engine 102 of the system 100 identifies the AI model 50 that has been provided (e.g., uploaded) for consumption by one or more of the applications 152. In an embodiment, the AI model scan engine 102 scans the AI model 50 to identify a set of one or more AI model attributes. For example, AI model scan engine 102 scans and parses a code set of one or more of the files 52 of the AI model 50 (e.g., ONNX-formatted model files) and identifies the set of AI model attributes (e.g., ONNX attributes) present in the AI model 50. Example AI model attributes include shapes, operators, inferences, etc. used to define the operations and functionality of the AI model 50. According to embodiments, the AI model scan engine 102 can identify standard AI model attributes (e.g., known or supported attributes) and custom AI model attributes (e.g., AI model attributes that are non-standard or created as a custom attribute by a model developer). In an embodiment, the AI model scan engine 102 may maintain a data structure storing information associated with the identified set of AI model attributes.

According to embodiments, the attribute risk assessment engine 104 analyzes each of the AI model attributes and determines a corresponding risk rating (the “attribute risk rating”). The attribute risk rating represents a level of potential threat or vulnerability to the one or more applications 152 or related data that is associated with a particular AI model attribute. In an example, the attribute risk rating for each AI model attribute may be classified into one of the following categories: a low risk rating, a medium risk rating, or a high risk rating.

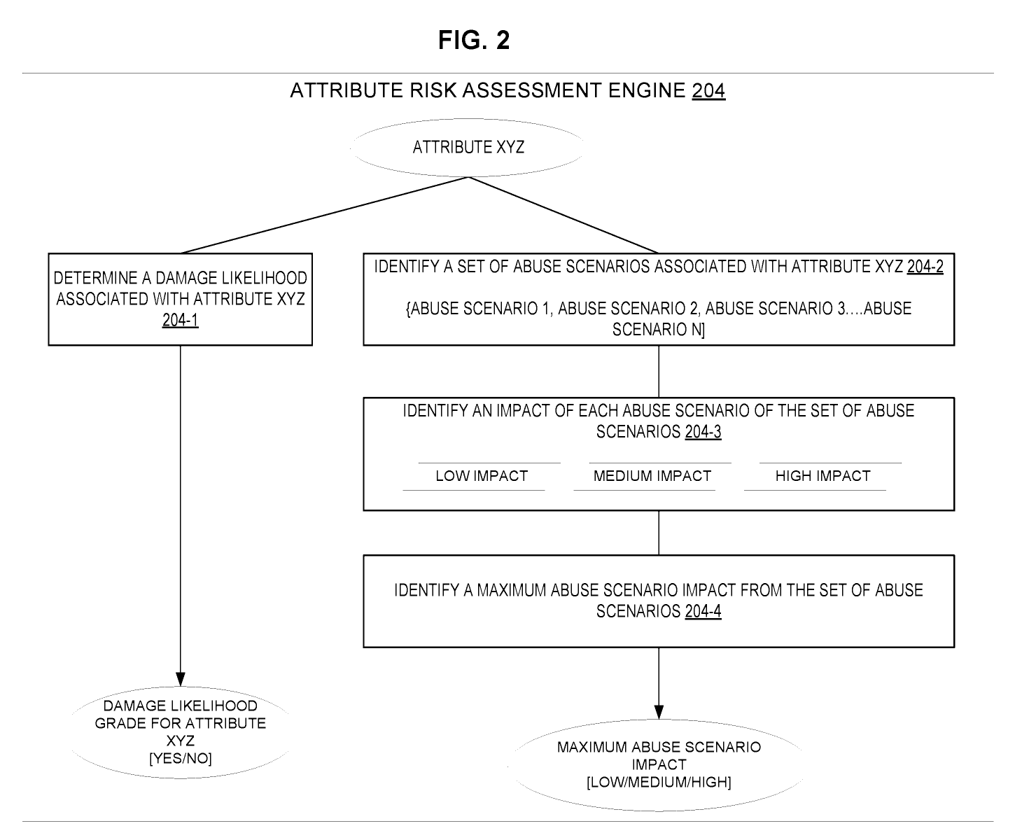

In an embodiment, the attribute risk assessment engine 104 for each identified AI model attribute, an attribute risk rating is determined based on a grade representing likelihood of a particular AI model attribute causing damage to the primary computing system 150 (the damage likelihood grade) and an impact rating associated with one or more abuse scenarios associated with the particular AI model attribute. Further details relating to the functionality of engine 104 are described below with reference to FIGS. 2-4.

FIG. 2 illustrates an example attribute risk assessment engine 204 configured to perform operations (e.g., operations 204-1 through 204-4) to generate an attribute risk rating for an example attribute (e.g., Attribute XYZ) associated with an ingested AI model (e.g., AI model 50 of FIG. 1), according to one or more embodiments.

As shown in FIG. 2, at operation 204-1, the attribute risk assessment engine 204 determines a damage likelihood associated with Attribute XYZ. According to embodiments, the risk assessment system determines a likelihood of a particular AI model attribute causing damage to the primary computing system (herein the “damage likelihood”). For example, for each AI model attribute, the attribute risk assessment engine 204 determines a damage likelihood grade (e.g., a “High/Yes” grade or “Low/No” grade) which represents whether the AI model attribute can cause potential damage to the one or more applications (e.g., applications 152 of FIG. 1) or cannot cause potential damage to the one or more applications.

As shown in FIG. 2, at operation 204-2, the attribute risk assessment engine 204 identifies a set of one or more abuse scenarios associated with Attribute XYZ. The abuse scenarios represent a vulnerability or potential security risk (e.g., a network security risk) associated with the particular AI model attribute (e.g., Attribute XYZ). Example abuse scenarios include, but are not limited to, an unauthorized model dumping scenario, an intellectual attribute theft or leakage scenario, a hyperparameter leakage scenario, a model retraining attack scenario, a model refitting with unauthorized data scenario, a malicious model alteration scenario, etc. In the example shown in FIG. 2, the attribute risk assessment engine 204 determines that Attribute XYZ is associated with a set of abuse scenarios including abuse scenario 1, abuse scenario 2, abuse scenario 3, … abuse scenario N; where N is an integer).

At operation 204-3, the attribute risk assessment engine 204 identifies an impact level associated with each of the abuse scenarios of the set of abuse scenarios. In an embodiment, the impact of each abuse scenario (e.g., the abuse scenario impact) represents a projected impact level to the primary computing system (e.g., an impact to the data and applications of the primary computing system) if the abuse scenario occurs. In an example, each abuse scenario impact may be categorized as one of high impact (e.g., a highest impact level), medium impact, or low impact (e.g., a lowest impact level).

At operation 204-4, based on the identified abuse scenario impacts for the set of abuse scenarios, the attribute risk assessment engine 204 identifies a maximum threat level associated with the one or more identified abuse scenarios. In an embodiment, an abuse scenario identified as having the maximum threat level (herein the “maximum threat abuse scenario”) is identified by evaluating the determined abuse scenario impact corresponding to each of the identified abuse scenarios. Accordingly, the attribute risk assessment engine 204 identifies an abuse scenario that has the highest relative impact. For example, if Attribute XYZ has one or more abuse scenario having a high impact, then the maximum abuse scenario impact is high. If, in another example, Attribute XYZ does not have any abuse scenarios with a high impact, but has one or more abuse scenarios with a medium impact, then the maximum abuse scenario impact is medium. If, in another example, Attribute XYZ does not have any abuse scenarios with a high impact or medium impact, then the maximum abuse scenario impact is low.

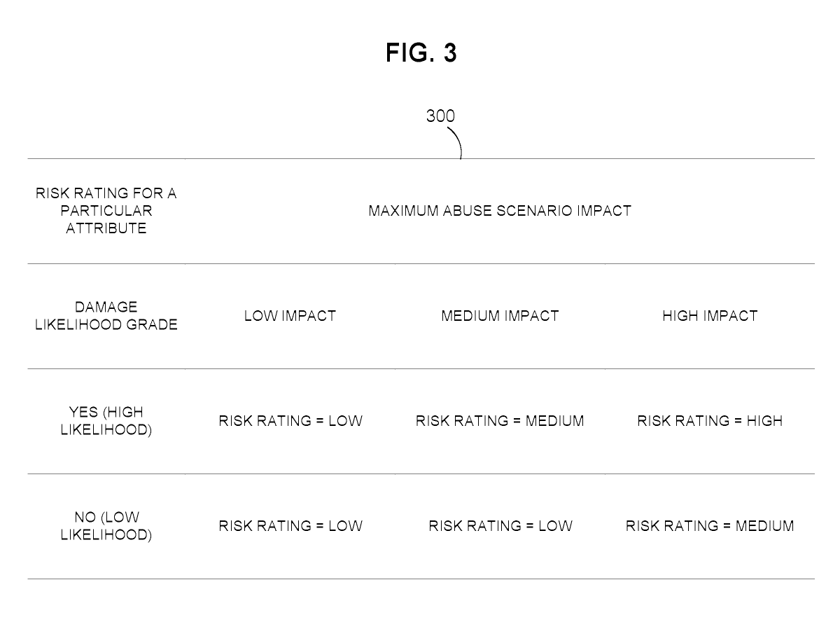

According to embodiments, having determined the damage likelihood grade and the maximum abuse scenario impact, the attribute risk assessment engine 204 determines an attribute risk rating for Attribute XYZ. FIG. 3 illustrates an example data structure including a set of conditions or rules 300 that can be employed by the attribute risk assessment engine 204 to determine the attribute risk rating for an AI model attribute (e.g., Attribute XYZ of FIG. 2), according to one or more embodiments. As shown, the risk rating for each particular AI model attribute is determined as function of the attribute’s damage likelihood grade and the maximum abuse scenario impact (as determined in accordance with FIG. 2).

For example, in accordance with a first condition, the AI model attribute of the AI model may be assigned a “High” attribute risk rating if the damage likelihood grade is “High/Yes” and the maximum abuse scenario impact corresponding to the set of potential abuse scenarios is “High Impact”. In another example, in accordance with a second condition, the AI model attribute of the AI model may be assigned a “Medium” attribute risk rating if the damage likelihood grade is “Low/No” and the maximum abuse scenario impact is “High Impact”. In another example, in accordance with a third condition, the AI model attribute of the AI model may be assigned a “Medium” attribute risk rating if the damage likelihood grade is “High/Yes” and the maximum abuse scenario impact is “Medium Impact”. In another example, in accordance with a fourth condition, the AI model attribute of the AI model may be assigned a “Low” attribute risk rating if the damage likelihood grade is “Low/No” and the maximum abuse scenario impact is either “Low impact” or “Medium Impact”. In another example, in accordance with a fifth condition, the AI model attribute of the AI model may be assigned a “Low” attribute risk rating if the damage likelihood grade is “High/Yes” and the maximum abuse scenario impact is “Low Impact”.

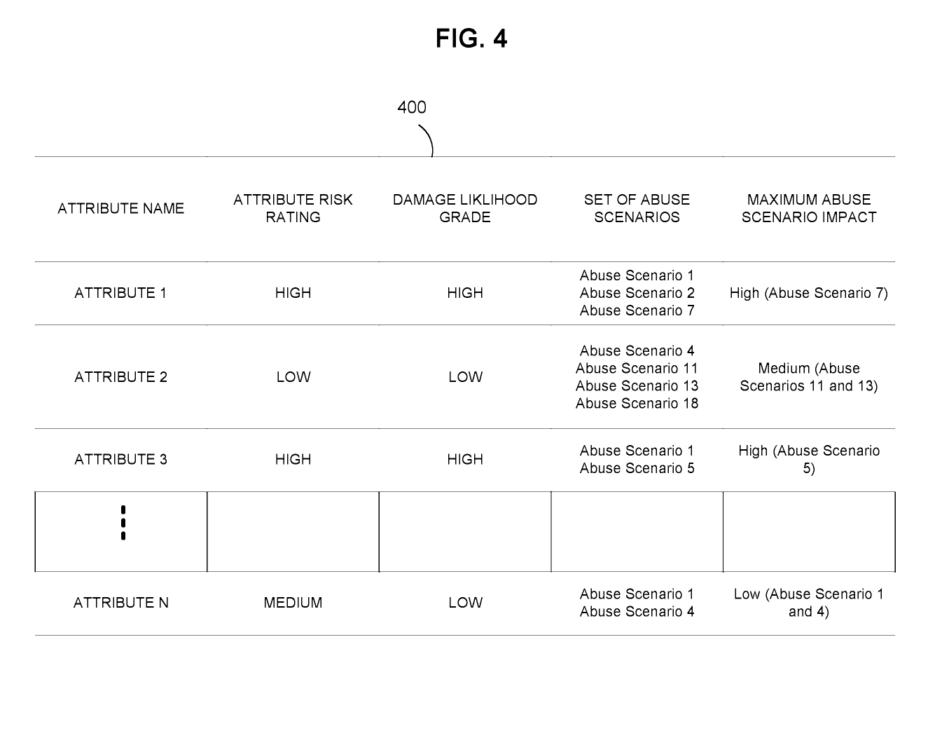

In an embodiment, the attribute risk assessment engine 104 generates the attribute risk rating for each identified AI model attribute and stores the rating information in the data structure including the set of AI model attributes. FIG. 4 depicts an example data structure 400 representing attribute risk rating information generated by processing logic (e.g., attribute risk assessment engine 104, 204 of FIGS. 1 and 2, respectively), according to one or more embodiments. As shown in the example of FIG. 4, a set of attributes (e.g., attribute 1, attribute 2, attribute 3…attribute N) associated with an AI model. As shown in FIG. 4, for each attribute, a set of abuse scenarios is identified. Based on the set of abuse scenarios, a maximum abuse scenario is identified. For example, for attribute 2, a set of abuse scenarios is identified including abuse scenario 4, abuse scenario 11, abuse scenario 13, and abuse scenario 18. Based on a review of the set of abuse scenarios and corresponding impact levels, it is determined that maximum abuse scenario impact for this set of abuse scenarios corresponds to abuse scenarios 11 and 13 (each of which have a “medium” impact level).

In the example shown in the data structure 400 of FIG. 4, a damage likelihood grade is identified for each attribute. In the example described above, for attribute 2, the damage likelihood grade is determined to be a “medium” grade. In an embodiment, using the conditions represented in FIG. 3, the processing logic determines an attribute risk rating for each of the attributes. For example, for attribute 2, it is determined that that the fourth condition is satisfied (e.g., attribute 2 is has a damage likelihood grade of “Low/No” and the maximum abuse scenario impact is “Medium Impact”), and accordingly, attribute 2 is assigned an attribute risk rating of “Low”. Example abuse scenarios include, but are not limited to, an unauthorized model dumping scenario, an intellectual attribute theft or leakage scenario, a hyperparameter leakage scenario, a model retraining attack scenario, a model refitting with unauthorized data scenario, a malicious model alteration scenario, etc.

With reference to FIG. 1, according to embodiments, based on the attribute risk rating information for the set of attributes associated with the AI model 50, the AI model risk assessment engine 106 determines an overall risk rating associated with the AI model 50 (e.g., the AI model risk rating). According to embodiments, an AI model risk rating may be assigned one of the following ratings: a low AI model risk rating, a medium AI model risk rating, a high AI model risk rating, or a critical AI model risk rating). In an embodiment, the AI model risk rating may be determined by comparing a number of identified AI model attributes having a high attribute risk rating (herein “Number_{HighAttributeRiskRating(HARR)}”) to one or more thresholds. For example, the N_{HARR} may be two (2) for an AI model corresponding to the attributes shown in FIG. 4 (e.g., attribute 1 and attribute 3 have a high attribute risk rating).

For example, the AI model risk rating for the AI model may be identified as “low” if the Number_{HARR} associated with the AI model is less than a first threshold level of high risk AI model attributes. In another example, the AI model risk rating for the AI model may be identified as “medium” if the Number_{HARR} associated with the AI model is greater than the first threshold level and greater than a second threshold level of high risk AI model attributes. In another example, the AI model risk rating may be identified as “high” if the if the Number_{HARR} associated with the AI model is greater than the second threshold level and less than a third threshold level of high risk AI model attributes. In another example, the AI model risk rating may be identified as “critical” if the if the Number_{HARR} associated with the AI model is greater than the third threshold level.

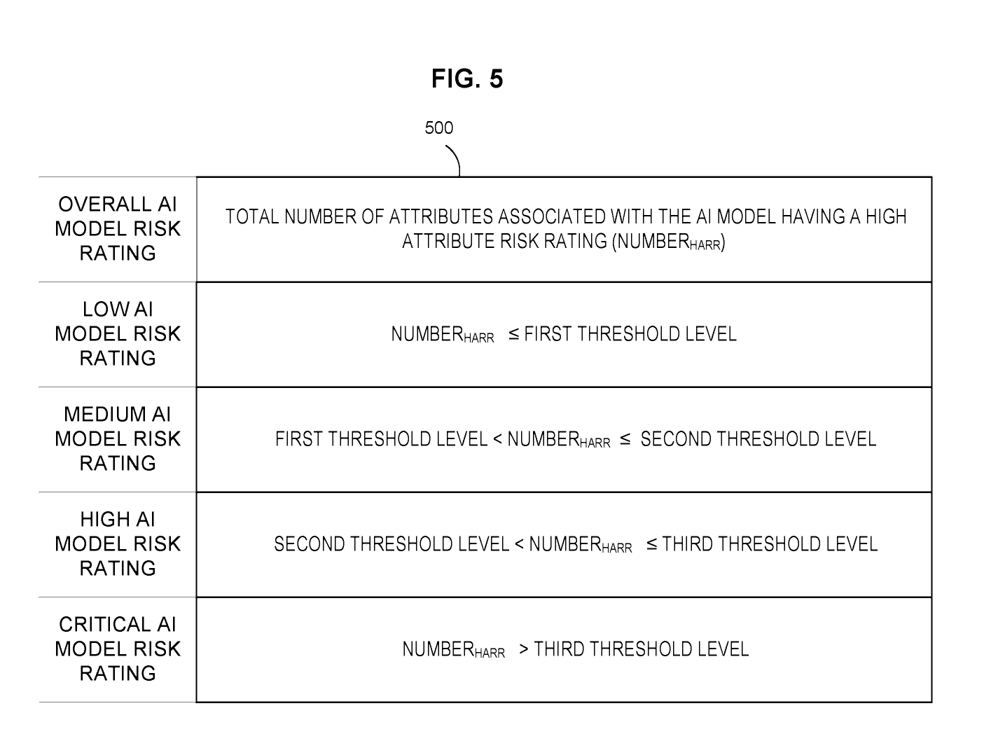

FIG. 5 illustrates an example data structure including a set of conditions or rules 500 that can employed by the AI model risk assessment engine 106 to determine an overall AI model risk rating, according to one or more embodiments. As shown, the risk rating the AI model (e.g., AI model 50 of FIG. 1) can be determined based on a comparison of the Number_{HARR} to one or more threshold levels (e.g., a first threshold level, a second threshold level, and a third threshold level; where the first threshold level is less than the second threshold level, which in turn is less than the third threshold level).

For example, the AI model risk rating for the AI model may be identified as “low” if a first condition is satisfied where the Number_{HARR} associated with the AI model is less than a first threshold level of high risk AI model attributes. In another example, the AI model risk rating for the AI model may be identified as “medium” if a second condition is satisfied where the Number_{HARR} associated with the AI model is greater than the first threshold level and greater than a second threshold level of high risk AI model attributes. In another example, the AI model risk rating may be identified as “high” if a third condition is satisfied where the Number_{HARR} associated with the AI model is greater than the second threshold level and less than a third threshold level of high risk AI model attributes. In another example, the AI model risk rating may be identified as “critical” if a further condition is satisfied where the Number_{HARR} associated with the AI model is greater than the third threshold level.

In an embodiment, the risk assessment system 100 may store an association between the generated AI model risk rating and the information identifying the AI model (e.g., an AI model identifier). In an embodiment, the risk assessment system 100 may generate a hash value representing the AI model risk rating associated with each AI model. According to embodiments, the risk assessment system 100 may use the hash value during a rescan (e.g., a subsequent ingestion of a previously assessed AI model) of the AI model as a uniquely identifiable signature of the AI Model and the associated risk rating.

As shown in FIG. 1, based on the determined AI model risk rating, the workflow manager 108 of the risk assessment system 100 may execute a selected action. In an embodiment, the action may include execution of a workflow (e.g., a network isolation workflow) of a set of workflows associated with the AI model 50. In an embodiment, the network isolation workflow includes a series of operations or steps configured to manage the processing the AI model 50 based on the level of risk the AI model 50 presents to one or more downstream applications 152 or users.

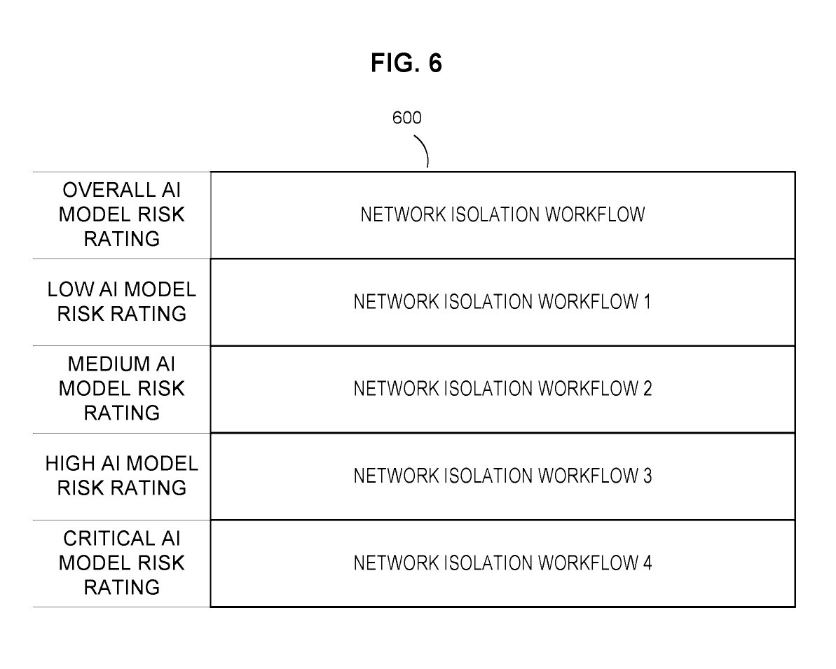

FIG. 6 illustrates an example data structure 600 including a mapping between an overall AI model risk rating and a corresponding network isolation workflow that may be used by the workflow manager 108, according to one or more embodiments. As shown in FIG. 6, in an example, the workflow manager 108 may select and execute network isolation workflow 1 for an AI model having a low AI model risk rating. In another example, the workflow manager 108 may select and execute network isolation workflow 2 for an AI model having a medium AI model risk rating. In another example, the workflow manager 108 may select and execute network isolation workflow 3 for an AI model having a high AI model risk rating. In another example, the workflow manager 108 may select and execute network isolation workflow 4 for an AI model having a critical AI model risk rating.

According to embodiments, the workflow manager 108 can configure the network isolation workflows using a suitable workflow management tool (e.g., in a software-defined network (SDN), an OpenShift SDN may be used).

According to embodiments, a network isolation workflow may include one or more steps, operations, processes configured to divide or partition a network associated with a primary or target computing system (e.g., a computing system associated with one or more applications 152 into one or more separate segments or subsets, each acting as its own smaller network (also referred to as “network segments”). According to embodiments, the workflow manager 108 is configured to execute a variety of different network isolation workflows having different degrees of network security or isolation levels associated with the underlying computing system that is configured to use the AI model.

In an embodiment, the configuration of a network isolation workflow may include the execution one or more steps or operations (e.g., network isolation operations) in accordance with a suitable network management architecture including, for example, executing operations relating to configuring a network cluster to enable communications between respective pods (e.g., groups of containers that share resources such as storage and network resources), executing operations relating to joining two or more projects to allow network traffic between pods and services in different projects, executing operations relating to isolating a project so that pods and services in other projects cannot access pods and services of the isolated project, executing operations relating to disabling network isolation for a project, etc.

For example, if the AI model risk rating is “critical”, the risk assessment system may cause execution of a first network isolation workflow having a highest isolation level. In another example, if the AI model risk rating is “high”, the risk assessment system may cause execution of a second network isolation workflow having a second highest isolation level. In another example, if the AI model risk rating is “medium”, the risk assessment system may cause execution of a third network isolation workflow having a third highest isolation level. In another example, if the AI model risk rating is “low”, the risk assessment system may cause execution of a fourth network isolation workflow having a lowest isolation level.

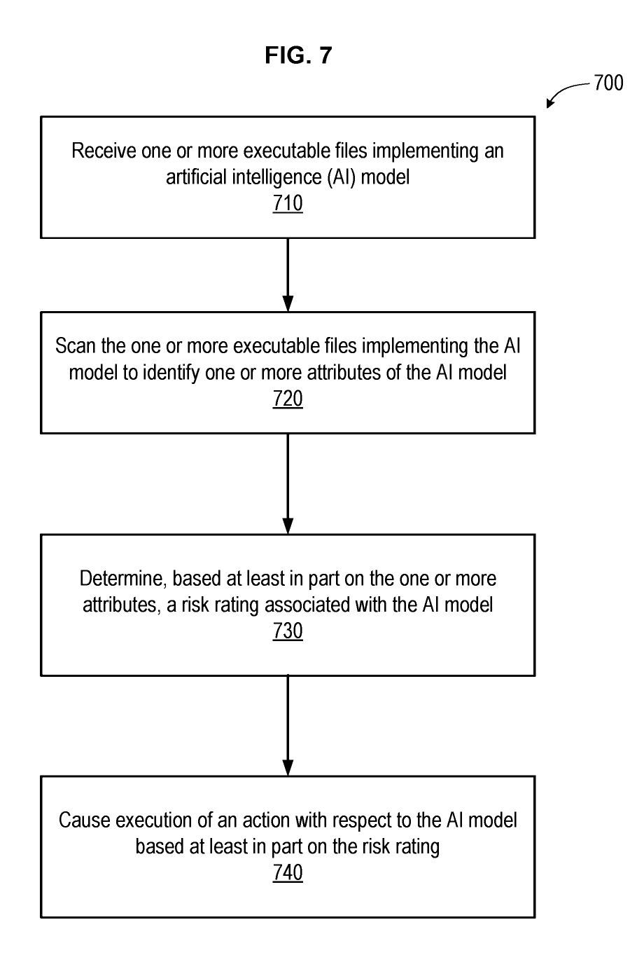

FIG. 7 is a flow diagram of an example method 700 related to assessing and managing a security risk level associated with an AI model ingested for use by one or more applications executed by a computing system, in accordance with at least some embodiments. Method 700 may be performed to determine a risk rating associated with an AI model and execute one or more actions based on the determined risk rating. According to embodiments, the method 700 may be performed by control logic (e.g., risk assessment system 100 of FIG. 1). Method 700 may be performed by the control logic associated with one or more processing units (e.g., CPUs and/or GPUs), which may include (or communicate with) one or more memory devices. Various operations of method 700 may be performed in a different order compared with the order shown in FIG. 7. Some operations of the methods may be performed concurrently with other operations. In at least one embodiment, one or more operations shown in FIG. 7 may not always be performed.

At block 710, control logic (e.g., risk assessment system 100 of FIG. 1) receives one or more executable files implementing an artificial intelligence (AI) model. According to embodiments, the one or more executable files implementing the AI model may be received from a third party source system (e.g., an untrusted third party computing system). In an embodiment, the one or more executable files implementing the AI model are to be used or executed by one or more applications or users of a computing system (e.g., a primary computing system).

At block 720, control logic scans the one or more executable files implementing the AI model to identify one or more attributes of the AI model. According to embodiments, the attributes of the AI model may include one or more operators, inferences, shapes, etc. In an embodiment, the control logic scans the code of the one or more executable files to identify or extract the set of attributes.

At block 730, control logic determines, based at least in part on the one or more attributes, a risk rating associated with the AI model. In an embodiment, the control logic determines a risk rating for each of the identified attributes. In an embodiment, for each attribute of the one or more attributes, control logic determines one or more abuse scenarios to which the respective attribute is vulnerable. In an embodiment, control logic determines an impact level associated with each abuse scenario of the one or more abuse scenarios. In an embodiment, control logic determines a damage likelihood associated with the respective attribute.

According to embodiments, control logic determines an attribute risk rating for each respective attribute based on the impact level associated with each abuse scenario of the one or more abuse scenarios for the respective attribute, and the damage likelihood associated with the respective attribute.

At operation 740, control logic causes execution of an action with respect to the AI model based at least in part on the risk rating. In an embodiment, execution of the action includes causing a network isolation workflow to be performed with respect to a computing system (e.g., a primary computing system) executing an application using the AI model. In an embodiment, control logic selects the network isolation workflow from a set of available network isolation workflows based on the risk rating associated with the AI model. In an embodiment, each network isolation workflow level represents a level of isolation of the AI model as it relates to the data and resources of the primary computing system. For example, if the AI model has a critical risk rating, then control logic causes execution of a network isolation workflow which provides the highest level of isolation of the AI model relative to the data, resources and applications of the primary computing system.

The systems and methods described herein may be used for a variety of purposes, by way of example and without limitation, to assess the risks associated with AI models used, for example, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models – such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as Open-USD, and/or other data types), systems implemented at least partially using cloud computing resources, and/or other types of systems.

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases) – such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, and/or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs – such as text, audio, video, image, etc. In some embodiments, LLM architectures such as recurrent neural networks (RNNs) or long short-term memory networks (LSTMs) may be used, while in other embodiments transformer architectures – such as those that rely on self-attention mechanisms – may be used to understand and recognize relationships between words or tokens. One or more generative processing pipelines that include LLMs may also include one or more diffusion block(s) (e.g., denoisers). The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type – including but not limited to those described herein – may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on April 20, 2023, the contents of which are hereby incorporated by reference in their entirety. In some embodiments, one or more additional models – or layers thereof – may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated – e.g., recursively – for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources – such as APIs, plug-ins, and/or the like.

In some embodiments, multiple language models (e.g., LLMs/VLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents – e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc. – as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model – or version, instance, or agent – maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 830. In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multimodal inputs, the input 801 may combine text with image data, audio data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 may be used to retrieve additional information to be used as part of the input 801 or prompt. For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve – using a vector search in an embedding space, for example – the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history – or at least a summary thereof – and include the prior conversation history along with the current ask/request as part of the input 801 to the generative LM 830.

The tokenizer 810 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data, the input processor 801 may resize the image data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features – such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multimodal data, the embedding component 820 may fuse representations of the different types of data (e.g., text, image, audio) using techniques like early fusion (concatenation), late fusion (sequential processing), attention-based fusion, etc.

The generative LM 830 and/or other components of the generative LLM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use – or capable of accessing or using – plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., third party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated – e.g., recursively – for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources – such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 810 of FIG. 8A) into tokens such as words, and each token is encoded (e.g., by the embedding component 820 of FIG. 8A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

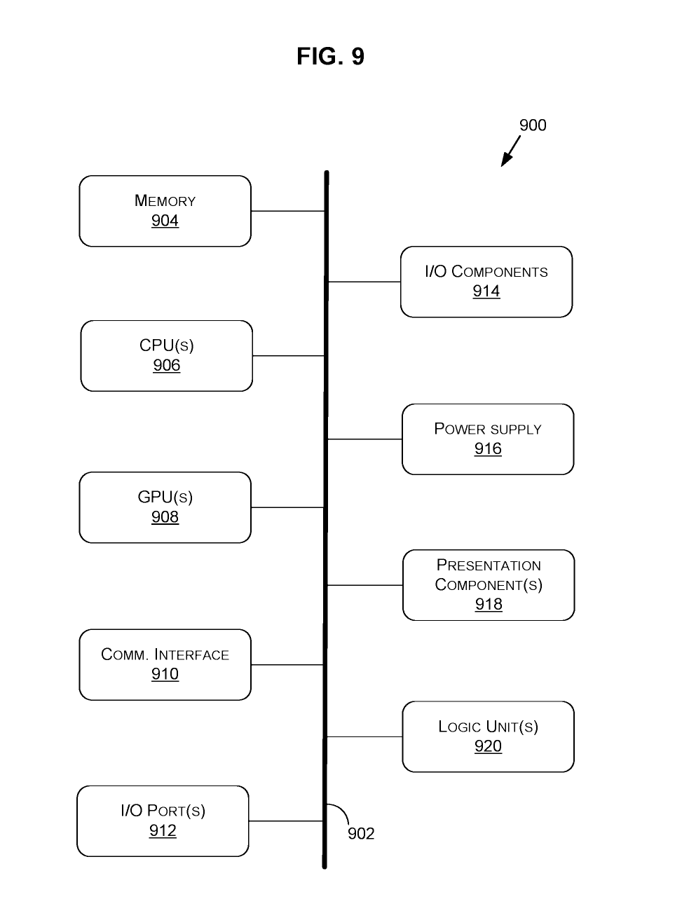

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using a communication interface such as NVIDIA® NVLink®) or may connect the GPUs through a switch (e.g., using a communication interface switch such as NVIDIA® NVSwitch®). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) – which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

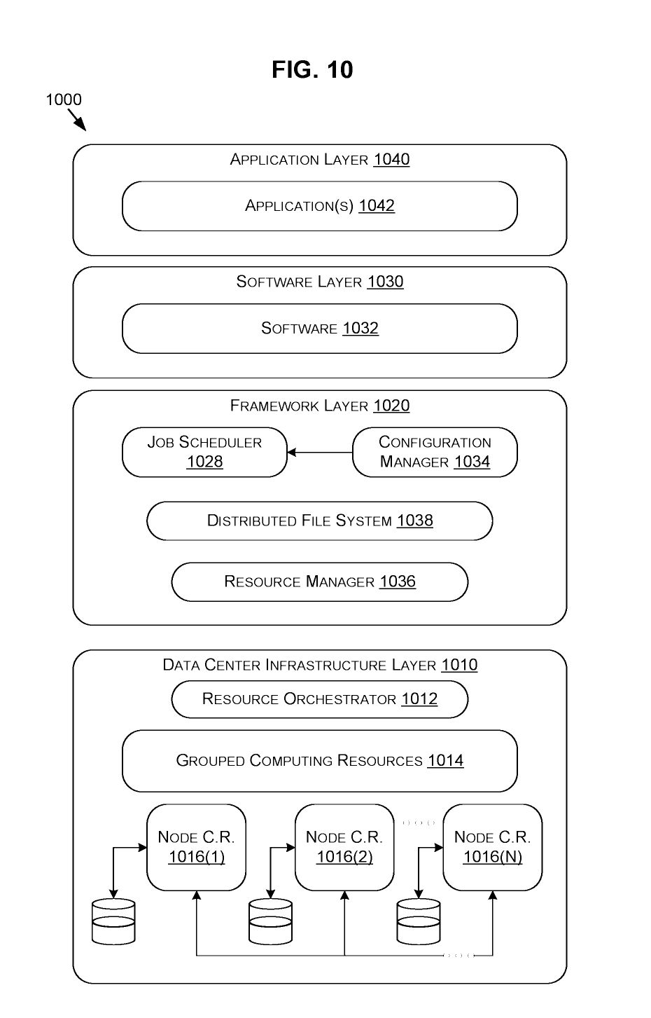

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-1016(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache SparkTM (hereinafter “Spark”) that may use distributed file system 1038 for large-scale data processing (e.g., "big data"). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10 – e.g., each device may include similar components, features, and/or functionality of the computing device(s) 1000. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments – in which case a server may not be included in a network environment – and one or more client-server network environments – in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving, by a computing system, one or more executable files implementing an artificial intelligence (AI) model;
scanning the one or more executable files implementing the AI model to identify one or more attributes of the AI model;
determining, based at least in part on the one or more attributes, a risk rating associated with the AI model; and
causing execution of an action with respect to the AI model based at least in part on the risk rating.

2. The method of claim 1, further comprising determining an attribute risk rating for each attribute of the one or more attributes associated with the AI model.

3. The method of claim 1, further comprising:
identifying, for each respective attribute of the one or more attributes, one or more abuse scenarios to which the respective attribute is vulnerable;
determining an impact level associated with each abuse scenario of the one or more abuse scenarios; and
identifying one or more abuse scenarios associated with the respective attribute having a highest impact level.

4. The method of claim 3, further comprising determining a damage likelihood associated with the respective attribute.

5. The method of claim 4, further comprising determining an attribute risk rating for each respective attribute based on the highest impact level associated with the one or more abuse scenarios for the respective attribute, and the damage likelihood associated with the respective attribute.

6. The method of claim 1, wherein the execution of the action comprises causing a network isolation workflow to be performed with respect to a computing system executing an application using the AI model.

7. The method of claim 6, wherein the network isolation workflow is selected from a set of network isolation workflows based at least in part on the risk rating associated with the AI model.

8. The method of claim 1, wherein risk rating associated with the AI model is determined based on comparing a number of attributes of the AI model having a high risk rating to one or more threshold levels.

9. The method of claim 8, wherein the risk rating associated with the AI model is a critical risk rating if a first condition of a set of conditions is satisfied.

10. The method of claim 9, wherein the first condition is satisfied if the number of attributes of the AI model having the high risk rating is greater than a highest threshold level of a set of threshold levels.

11. A system comprising:
a memory device; and
a processing device coupled to the memory device, wherein the processing device performs operations comprising:
receiving one or more executable files implementing an artificial intelligence (AI) model;
scanning the one or more executable files implementing the AI model to identify one or more attributes of the AI model;
determining, based at least in part on the one or more attributes, a risk rating associated with the AI model; and
causing execution of an action with respect to the AI model based at least in part on the risk rating.

12. The system of claim 11, the operations further comprising determining an attribute risk rating for each attribute of the one or more attributes associated with the AI model.

13. The system of claim 11, the operations further comprising:
identifying, for each respective attribute of the one or more attributes, one or more abuse scenarios to which the respective attribute is vulnerable;
determining an impact level associated with each abuse scenario of the one or more abuse scenarios; and
identifying one or more abuse scenarios associated with the respective attribute having a highest impact level.

14. The system of claim 13, the operations further comprising determining a damage likelihood associated with the respective attribute.

15. The system of claim 14, the operations further comprising determining an attribute risk rating for each respective attribute based on the highest impact level associated with the one or more abuse scenarios for the respective attribute, and the damage likelihood associated with the respective attribute.

16. The system of claim 15, wherein the execution of the action comprises:
selecting, based at least in part on the risk rating associate with the AI model, a network isolation workflow is selected from a set of network isolation workflows; and
causing the network isolation workflow to be performed with respect to a computing system executing an application using the AI model.

17. The system of claim 11, wherein risk rating associated with the AI model is determined based on comparing a number of attributes of the AI model having a high risk rating to one or more threshold levels, and wherein the risk rating associated with the AI model is a critical risk rating if a first condition of a set of conditions is satisfied, and wherein the first condition is satisfied if the number of attributes of the AI model having the high risk rating is greater than a highest threshold level of a set of threshold levels.

18. A non-transitory computer readable storage medium comprising instructions that, when executed by a processing device, cause the processing device to perform operations comprising:
receiving one or more executable files implementing an artificial intelligence (AI) model;
scanning the one or more executable files implementing the AI model to identify one or more attributes of the AI model;
determining, based at least in part on the one or more attributes, a risk rating associated with the AI model; and
causing execution of an action with respect to the AI model based at least in part on the risk rating.

19. The non-transitory computer readable storage medium of claim 18, the operations further comprising determining an attribute risk rating for each attribute of the one or more attributes associated with the AI model.

20. The non-transitory computer readable storage medium of claim 18, the operations further comprising:
identifying, for each respective attribute of the one or more attributes, one or more abuse scenarios to which the respective attribute is vulnerable;
determining an impact level associated with each abuse scenario of the one or more abuse scenarios; and
identifying one or more abuse scenarios associated with the respective attribute having a highest impact level.
